(19) United States
(12) Patent Application Publication
(10) Pub. No.: US 2023/0142797 A1
(43) Pub. Date: May 11, 2023

(54) METHOD AND APPARATUS FOR LEARNING LOCALLY-ADAPTIVE LOCAL DEVICE TASK BASED ON CLOUD SIMULATION

(71) Applicant: ELECTRONICS AND TELECOMMUNICATIONS RESEARCH INSTITUTE, Daejeon (KR)

(72) Inventors: Tae Woo KIM, Daejeon (KR); Jae Hong KIM, Daejeon (KR); Chan Kyu PARK, Daejeon (KR); Woo Han YUN, Daejeon (KR); Ho Sub YOON, Daejeon (KR); Min Su JANG, Daejeon (KR)

(73) Assignee: ELECTRONICS AND TELECOMMUNICATIONS RESEARCH INSTITUTE, Daejeon (KR)

(21) Appl. No.: 17/941,892

(22) Filed: Sep. 9, 2022

(30) Foreign Application Priority Data
Nov. 11, 2021 (KR) 10-2021-0154844
Jul. 11, 2022 (KR) 10-2022-0085012

(51) Int. Cl. G06N 20/00; B25J 9/16

(52) U.S. Cl. CPC G06N 20/00; B25J 9/163; B25J 9/1605

(57) ABSTRACT

Disclosed herein a method and apparatus for learning a locally-adaptive local device task based on cloud simulation. According to an embodiment of the present disclosure, there is provided a method for learning a locally-adaptive local device task. The method comprising: receiving observation data about a surrounding environment recognized by a local device; performing a domain randomization based on the observation data and a failure type of a task assigned to the local device and relearning a policy network of the assigned task based on the domain randomization; and updating a policy network of the local device for the assigned task by transmitting the relearned policy network to the local device.

### CROSS REFERENCE TO RELATED APPLICATION

The present application claims priority to Korean patent applications 10-2021-0154844, filed Nov. 11, 2021, and 10-2022-0085012, filed Jul. 11, 2022, the entire contents of which are incorporated herein for all purposes by this reference.

### BACKGROUND OF THE INVENTION

### Field of the Invention

The present disclosure relates to a method and apparatus for learning a locally-adaptive local device task, and more particularly, to a method and apparatus for learning a locally-adaptive local device task based on cloud simulation.

### Description of the Related Art

The conventional robot learning utilizes a method of learning a policy through simulation mainly in a local environment and then applying the policy to an actual environment. In particular, to execute a task for a new environment or object, relearning or adaptive learning needs to be performed by adding new data to existing data. However, an existing adaptive learning method, which has been widely used, has limited performance and also has not completely overcome the problem of losing an already learnt technique (catastrophic forgetting). A relearning method, which constantly adds data in a local environment, requires a lot of time and cost and is inefficient. Learning using a simulation also requires a lot of time and endeavor to build new environment data, and many computing resources are also indispensable.

As an environment like cloud is recently provided in which massive computing resources are available, a task becomes possible which is expected to collect/process a larger amount of computation and massive data. In the existing relearning study for local adaptation, there is no method of utilizing a simulation environment based on cloud, and there is also no methodology for responding to various environments and variables.

### SUMMARY

A technical object of the present disclosure is to provide a method and apparatus for learning a locally-adaptive local device task based on cloud simulation.

Other objects and advantages of the present invention will become apparent from the description below and will be clearly understood through embodiments. In addition, it will be easily understood that the objects and advantages of the present disclosure may be realized by means of the appended claims and a combination thereof.

Disclosed herein a method and apparatus for learning a locally-adaptive local device task based on cloud simulation. According to an embodiment of the present disclosure, there is provided a method for learning a locally-adaptive local device task. The method comprising: receiving observation data about a surrounding environment recognized by a local device; performing a domain randomization based on the observation data and a failure type of a task assigned to the local device and relearning a policy network of the assigned task based on the domain randomization; and updating a policy network of the local device for the assigned task by transmitting the relearned policy network to the local device.

According to the embodiment of the present disclosure, wherein the relearning performs the domain randomization by reflecting data about the failure type collected from at least one or more other local devices.

According to the embodiment of the present disclosure, wherein the failure type of the assigned task comprises at least one of recognition failure, manipulation failure, or collision avoidance failure or combination thereof.

According to the embodiment of the present disclosure, wherein the relearning performs the domain randomization by using, in case of the recognition failure, at least one strategy among a change of a target object in color, texture, lighting and position, parameters of a camera sensor, and class mixture of the target object.

According to the embodiment of the present disclosure, wherein the relearning performs the domain randomization by using, in case of the manipulation failure, at least one strategy among placement of a plurality of target objects with a same class, a change of an initial location and a position of the target object, a change in a physical property of a manipulator of the local device, and a change in a physical property of the target object.

According to the embodiment of the present disclosure, wherein the relearning performs the domain randomization by using, in case of the collision avoidance failure, at least one strategy among generation of random obstacles and then a change in color, texture, lighting and shape, a change in an initial location and a position of the random obstacles, a change in a size scale of the random obstacles, a change in an initial linear velocity and an angular velocity of the random obstacles, application of an external force to the random obstacles, and a change in a physical property of the random obstacles.

According to the embodiment of the present disclosure, wherein the receiving receives the observation data, a surrounding environment recognition result recognized by a local simulation of the local device, and the policy network of the assigned task.

According to another embodiment of the present disclosure, there is provided a method for learning a locally-adaptive local device task. The method comprising: obtaining observation data about a surrounding environment; configuring a local simulation environment by using the observation data; predicting possibility of success for an assigned task by using the local simulation environment; requesting, to a cloud server, relearning of a policy network of the assigned task, when the assigned task is determined to be failure; and updating the policy network of the assigned task by receiving a relearned policy network from the cloud server.

According to another embodiment of the present disclosure, there is provided an apparatus for learning a locally-adaptive local device task. The apparatus comprising: a receiver configured to receive observation data about a surrounding environment recognized by a local device; a relearning unit configured to perform a domain randomization based on the observation data and a failure type of a task assigned to the local device and to relearn a policy network of the assigned task based on the domain randomization; and a transmitter configured to transmit the relearned policy network to the local device so as to update a policy network of the local device for the assigned task.

The features briefly summarized above with respect to the present disclosure are merely exemplary aspects of the detailed description below of the present disclosure, and do not limit the scope of the present disclosure.

According to the present disclosure, it is possible to provide a method and apparatus for learning a locally-adaptive local device task based on cloud simulation.

Effects obtained in the present disclosure are not limited to the above-mentioned effects, and other effects not mentioned above may be clearly understood by those skilled in the art from the following description.

### BRIEF DESCRIPTION OF THE DRAWINGS

FIG. 1 is a view showing a concept of a process of learning a locally-adaptive robot task based on a cloud simulation.

FIG. 2 is a flowchart for an operation of an embodiment for describing a process of learning a locally-adaptive robot task.

FIG. 3 is a view for describing a process of configuring a local simulation for verifying an assigned task.

FIG. 4 is a flowchart for a method for learning a locally-adaptive local device task according to an embodiment of the present disclosure.

FIG. 5 is a view showing a process of verifying the possibility of manipulation and adaptive learning in a cloud server.

FIGS. 6A to 6C are views showing an example of a visualized result for each failure type of a robot.

FIG. 7 is a view showing an example of a domain randomization strategy using a change in parameters of a camera sensor in case of recognition failure.

FIG. 8 is a view showing an example of a domain randomization strategy using a change in parameters of a manipulator and in parameters of a target object in case of manipulation failure.

FIG. 9 is a view showing an example of a domain randomization strategy using a change in parameters of an obstacle in case of collision avoidance failure.

FIG. 10 is a view showing a configuration of a locally-adaptive local device task learning system according to another embodiment of the present disclosure.

FIG. 11 is a view illustrating a configuration of a device to which an apparatus for learning a locally-adaptive local device task is applied according to another embodiment of the present disclosure.

### DETAILED DESCRIPTION OF THE INVENTION

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

In the present document, such phrases as ‘A or B’, ‘at least one of A and B’, ‘at least one of A or B’, ‘A, B or C’, ‘at least one of A, B and C’ and ‘at least one of A, B or C’ may respectively include any one of items listed together in a corresponding phrase among those phrases or any possible combination thereof.

In embodiments of the present disclosure, the main idea is that a local device (or local agent) effectively performs explores and relearns a variable environment through a simulation using a cloud computing resource by focusing on a situation in a current local environment, to which the local device (or local agent) is subject.

In embodiments of the present disclosure, it is possible to effectively relearn a policy network for a task of a local device by combining a cloud-based simulation technology and a case-by-case environment reconfiguration technology.

For example, in embodiments of the present disclosure, a learning method may be provided to enable a local device like a robot to adapt to an unfamiliar local environment and thus to successfully perform a task, and the robot may be relearn a tasking skill by utilizing a local and cloud-based simulation. Particularly, for effective adaptation even to various unpredictable situation in a local environment, a simulation-based relearning technology considering various situations and variables may be provided.

In embodiments of the present disclosure, in order to enable a robot to successfully perform a task in a new environment, domain randomization for each situation of a local environment may be performed based on a cloud simulator so that relearning and adaptive learning are possible for a policy network for the task of the robot, and a local simulation verification process may be included to reduce the load of a cloud server and to reduce risk due to the failure of task in a real environment (or an actual environment). In addition, a 3D target object may be registered to a simulator by using a visual sensor in an actual environment and then may be used for adaptive learning.

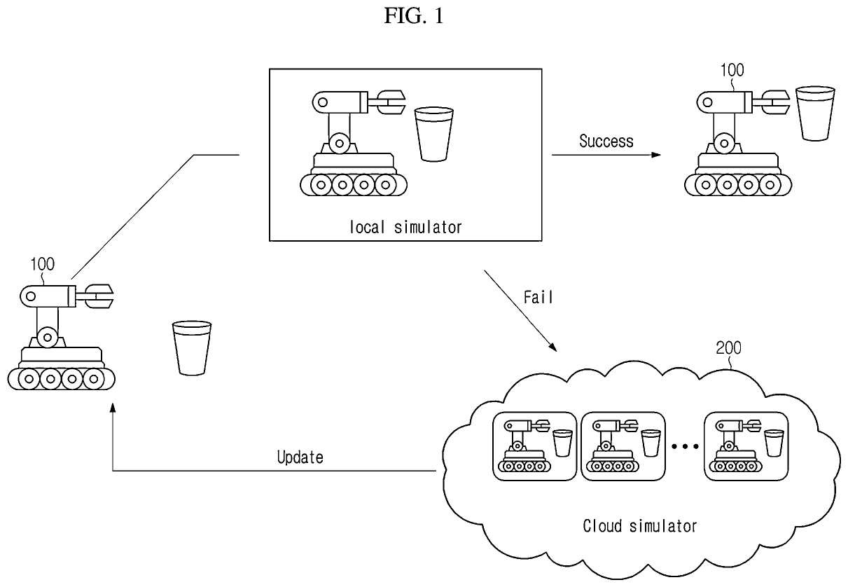

FIG. 1 is a view showing a concept of a process of learning a locally-adaptive robot task based on a cloud simulation. As illustrated in FIG. 1, it is assumed that a robot agent 100 takes a mission of grasping a glass after moving from a family environment A to a family environment B, that is, another environment which it has not experienced during a learning process but is not a complete new environment. As both the surrounding environment and the target object of task are not familiar, the probability of failure is high, and there is also a risk associated with the failure, for example, breaking the glass. Accordingly, the task of grasping the glass is first verified using a local simulator present in the robot device 100, and when the verification shows that the chance of success is high, the task of grasping the glass is performed in the actual environment. On the other hand, when a verification result using a local simulation is determined to be a high chance of failure, the possibility of successful task should be enhanced through relearning. However, this is practically unrealistic, as a local environment has many limitations in terms of time, computing resources and the like. Accordingly, a policy network for the task is updated by uploading observation data of the current environment and task into the cloud server 200, performing relearning of the policy network for the glass grasping task by using massive computing resources and then transmitting the relearned policy network to the robot 100. During the relearning process, the cloud server 200 may maximize the adaptability of the robot agent by utilizing a domain randomization technique, and after the relearning of the policy network is completed and the policy network is updated into the local device 100, the glass grasping task is attempted again.

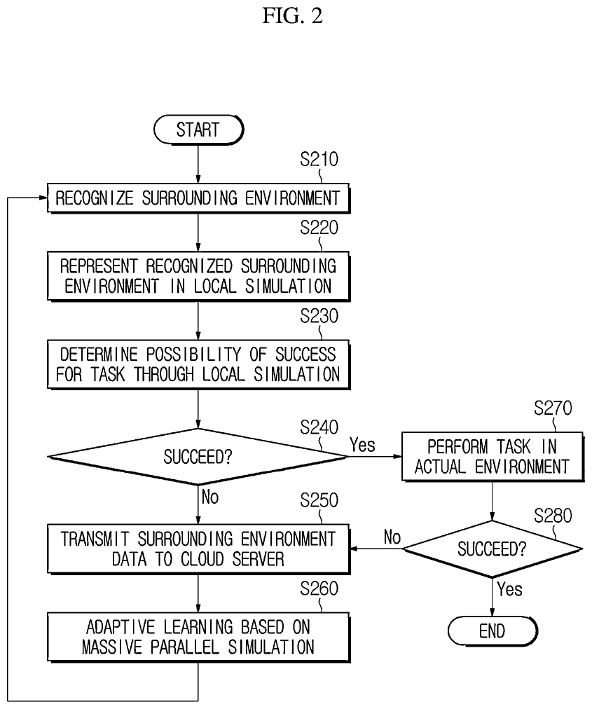

FIG. 2 is a flowchart for an operation of an embodiment for describing a process of learning a locally-adaptive robot task. As illustrated in FIG. 2, when taking a new mission in a local environment, a robot agent first recognizes the local environment through various sensors like a RGB camera, a depth image sensor (depth sensor) and a Lidar sensor (S210). That is, at step S210, observation data (e.g., images, voice signals) or environment data for the surrounding environment of a robot are obtained by various sensors installed in the robot such as a RGB camera, a depth camera and a Lidar sensor.

Next, after a current local environment is represented (simulated) into a simulator (local simulator) of a local device, the possibility of success in performing a task is verified by simulating a task for accomplishing a given mission in simulation (S220, S230).

Herein, at step S220, interaction data with persons may be processed, and a local simulation environment for simulating a manipulation of the robot is generated based on an environment of the observation data by identifying a person's command, whether or not there is a target object, and the like from the observation data, so that a local simulation environment for simulating a manipulation or task of the robot may be configured.

At step S230, the possibility of success or the possibility of performance may be verified (or predicted) by performing an actual task simulation from the local simulation environment. According to an embodiment, at step S230, through a simulation using a policy network of an assigned task, input data, for example, a command signal for a mission, and an output result for observation data, for example, a trajectory action of the robot or robot arm may be checked, and the possibility of succeeding the task may be verified through the output result. Herein, the command signal for the mission may be received through an interaction with a person or be automatically received according to a command signal corresponding to a preset task. As an example, at step S230, when a task of putting a specific object into a box is performed, the possibility of success may be verified by analyzing a trajectory action of the robot arm through simulation and thus by verifying whether or not the specific object is put into a box.

When it is determined, through the verification of the possibility of successfully performing the task through a local simulation, that the task is possible to be successful, the task is performed in an actual environment, and when, as a determination result of step S240, the possibility of successfully performing the task is determined to be low, the current observation data, that is, surrounding environment data recognized by a cloud server is transmitted to the cloud server, the policy network of the task is relearned through adaptive learning based on massive parallel simulation in the cloud server, and then the relearned policy network is updated to the local device again (S240 to S260). According to an embodiment, at step S260, the policy network of the task may be relearned by performing domain randomization for a failure type of the task.

Herein, at step S250, not only the surrounding environment data (or observation data) but also the policy network of the robot for the assigned task and the environment recognition result (e.g., an environment model represented by the local simulator using the observation data) may be transmitted to the cloud server.

In addition, when the task performed in the actual environment of step S270 results in failure, the surrounding environment data recognized by the robot is transmitted to the cloud server, the policy network of the task is relearned through adaptive learning based on massive parallel simulation in the cloud server, and then the relearned policy network is updated to the local device again (S280, S250, S260).

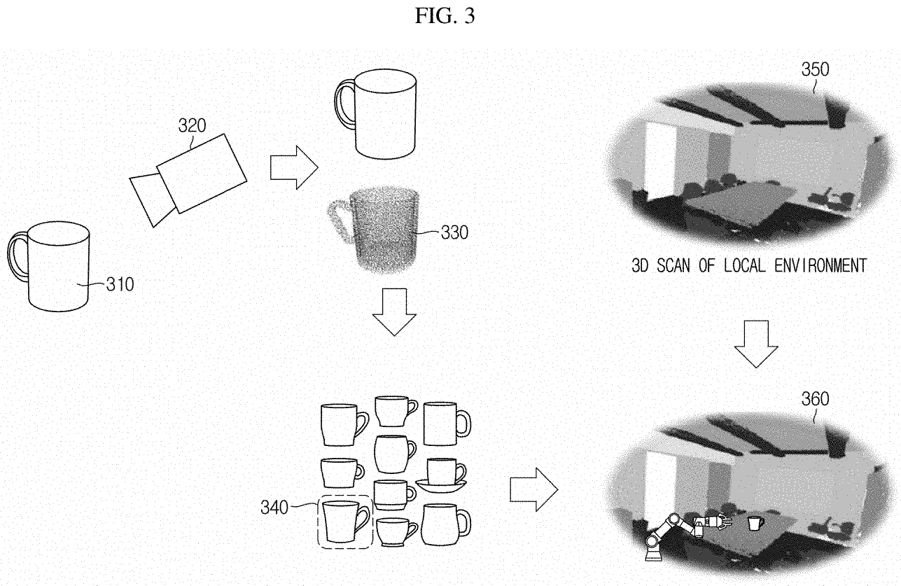

FIG. 3 is a view for describing a process of configuring a local simulation for verifying an assigned task, that is, a view for describing a process of generating an environment model at step S220 of FIG. 2. As illustrated in FIG. 3, in a local simulation configuration process for verifying an assigned task, a local environment, in which a robot performs a mission or task, is scanned using a RGB sensor, a Lidar sensor, and a depth sensor and then is represented in a simulation 350 of a local device based on point cloud data. In the case of a target object to be tasked in a local environment, for example, a mug cup 310, point cloud data 330 and image information are obtained also through scanning using sensors 320, and then a class of an object is classified based on the image information. That is, a target object is classified as a mug cup. Herein, the class classification may be performed by an image analysis through image processing or be performed through a classifier of a prelearned model.

A mesh model 340 with a most similar shape is retrieved based on a recognized class through the cloud server and then is downloaded into a local simulation environment to simulate (360) the task. Herein, the mesh model matching may use an existing iterative closest point (ICP)-based method that is widely used, and any method capable of performing mesh model matching may also be used.

In case an assigned task has sufficiently verified in an existing learning process, it is advantageous to immediately perform the task in an actual environment. However, when the task is immediately performed for a new object in an actual environment that is a new environment which has not been sufficiently encountered, there is risk of failure. In case a target object is a fragile thing like a glass with a new shape, when a robot misses the object while grasping and manipulating it, there is a danger of breaking the glass, and a corresponding cost occurs. In embodiments of the present disclosure, such a risky burden and a cost caused by the failure of task may be reduced through a local simulation. For example, in embodiments of the present disclosure, the possibility of performing a task may be verified in advance in a local simulation environment that consists of a local environment and target object models obtained through various sensors, and thus the risky burden and cost may be reduced. In addition, since verification is performed not in a cloud server but in a local device, for example, a robot, a time for uploading and downloading local environment data may be saved, and it is possible to solve the problem of excessive burden on the cloud server, which may occur when the number of local devices becomes excessive.

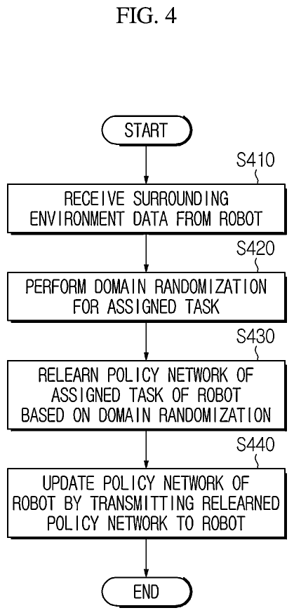

FIG. 4 is a flowchart for a method for learning a locally-adaptive local device task according to an embodiment of the present disclosure, and this view shows a flowchart for an operation in a cloud server. The description below assumes that a local device is a robot.

Referring to FIG. 4, in the method for learning a locally-adaptive local device task according to an embodiment of the present disclosure, surrounding environment data recognized by various sensors of a locally-adaptive robot, for example, observation data about surrounding environment is received from the robot, and domain randomization for a task assigned to the robot is performed based on the received surrounding environment data (S410, S420).

Herein, at step S410, as described in FIG. 2, in case manipulation is impossible or recognition fails for a task assigned through a local simulation of the robot, observation data about the surrounding environment may be received from the robot, and a policy network for the assigned task and an environment recognition result may also be received together.

A cloud server may collect and store data received from a plurality of local devices as well as data received from the robot, and at step S420, by using various data thus collected and stored, domain randomization, to which various variables are applied, may be generated or performed mainly on a part with a seemingly high probability of failure while the robot, which transmits the data of step S410, is performing the task. Herein, at step S420, the domain randomization on every element will be very ineffective since a lot of time and costs are required. Accordingly, the domain randomization may be performed only when it is determined to be necessary in terms of recognition, manipulation and collision avoidance, and Table 1 below shows the description of each technique and the criteria of determination for selective domain randomization.

TABLE 1

| Classification | | Criteria for determining the |
|---|---|---|
| of techniques | Description | absence of technique |
| Recognition | Technique of recognizing | Robot and its manipulator |
| | and classifying target | fail to be within a |
| | objects | predetermined distance |
| | | from a target object. |
| Manipulation | Technique of | Approach to a target object is |
| | manipulating a | successful but grasping and |
| | recognized target object | transporting it properly fails. |
| Collision | Technique of recognizing | Collision with an obstacle and |
| avoidance | an obstacle and a | a surrounding environment |
| | surrounding environment | occurs during a task |
| | and avoiding collision | |
| | therewith | |

When the domain randomization for the assigned task of the robot is performed at step S420, the policy network of the assigned task of the robot is relearned based on the performed domain randomization, and as the relearned policy network is transmitted to the robot, the policy network for the assigned task of the robot is updated (S430, S440).

Herein, at step S430, after domain-randomized various environments, for example, various environments with a randomized domain based on failure types of tasks are configured, an assigned task is relearned based on the various environments in order to enhance the success rate in performing the task in a new environment, and at step S440, when relearning of the policy network of the assigned task is completed, the relearned policy network may be transmitted to the local robot so that the relearned policy network may be updated in the local robot.

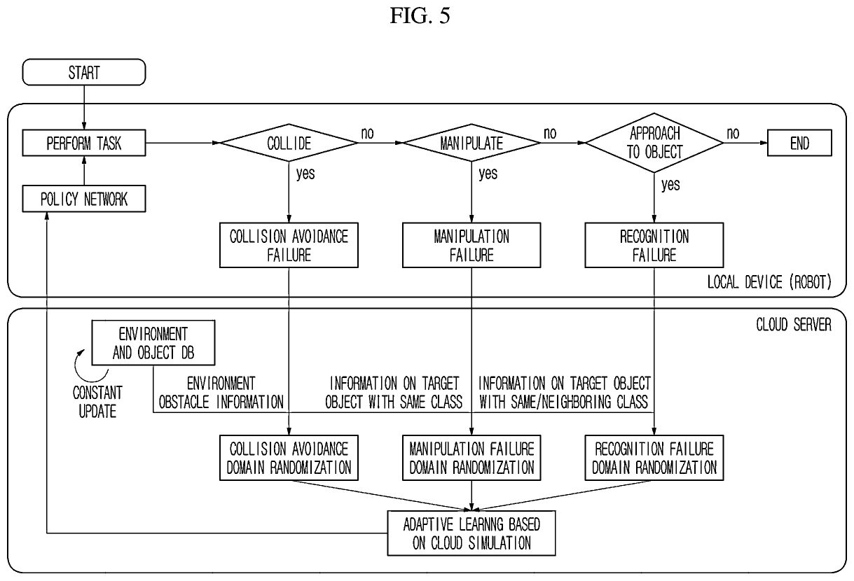

FIG. 5 is a view showing a process of verifying the possibility of manipulation and adaptive learning in a cloud server.

As illustrated in FIG. 5, a local device, for example, a robot executes a verification process for performing an assigned task in a local simulation environment before it performs the task using a policy network, for example, before it manipulates a target object in an actual environment. Herein, during the verification process, types of failure may be classified into preset situations, for example, recognition failure, manipulation failure, and collision avoidance failure. First, a robot performs a target task during a given number of episodes and records the process and then determines a failure type. Each case of failure is determined according to the classification criteria of Table 1 above, and in case of failure, domain randomization is performed based on a corresponding criterion of classification. Herein, when a plurality of failures occurs, a plurality of domain randomizations may be performed for each failure. For example, in case, while grasping and transporting a target object, a robot collides with an obstacle and misses the object, manipulation failure and collision avoidance failure may occur at the same time in a single episode. Herein, a cloud server may perform a domain randomization of manipulation failure and a domain randomization of collision avoidance failure simultaneously during adaptive learning. In a process of domain randomization, the cloud server may retrieve and utilize environment/object information necessary for randomization from environment/object DB of a cloud, and the environment/object DB may be constantly updated.

By performing adaptive learning based on a cloud simulation through a domain randomization according to each task failure, the cloud server may update a policy network for a task of a robot by relearning the policy network for the task of the robot and transmitting the policy network thus relearned to the robot.

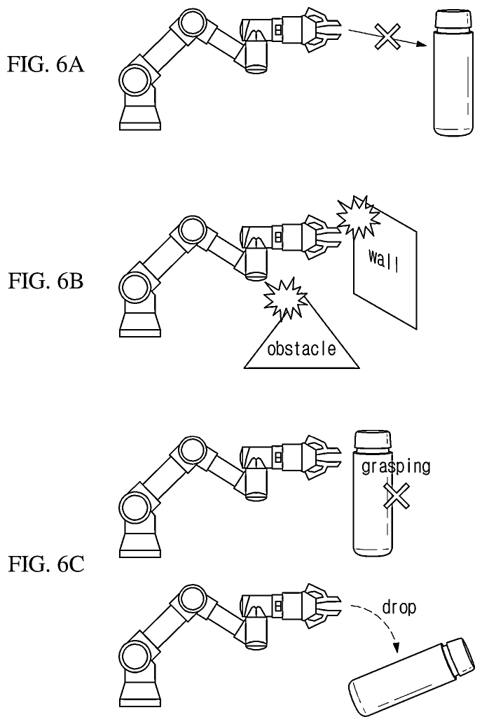

FIGS. 6A to 6C are views showing an example of a visualized result for each failure type of a robot, and it is a view showing examples of recognition failure (FIG. 6A), collision avoidance failure (FIG. 6B), and manipulation failure (FIG. 6C) in Table 1 above.

The criteria of determination for each failure type are described in Table 1, and the grounds for them are as follows. In case a robot fails even to be within a predetermined distance from a target object, it is possible to interpret that the robot fails to recognize the target object as an object to perform a task on it. Accordingly, this case is determined to be the type of recognition failure (FIG. 6A). In addition, in case the robot collides with a surrounding environment, for example, the floor, a wall and an obstacle while performing the task by means of a manipulator, it is considered as collision avoidance failure (FIG. 6B). In addition, although the robot succeeds in approaching the target object, when the robot fails to grasp the target object by using its manipulator, or although successfully grasping the object, when the robot fails to transport the target object to a target position, for example, when the robot misses the target object while carrying it, this case is considered as manipulation failure (FIG. 6C).

In case the robot fails during verification of a new task in a local simulation environment, relearning is performed through a cloud server. A relearning process may mean relearning or adaptive learning of a policy after an environment is set up where a task can be successfully performed not only using an already learned technique of performing the task but also in a failed situation. In a process of setting up an environment again in a simulation of a cloud server, failed situations diversely distributed so that a task can be successful through smooth adaptation to a similar failure situation, and this process is referred to as domain randomization. In an embodiment of the present disclosure, an effective domain randomization may be ensured by applying a domain randomization suitable for each failure type.

As a randomization scope in a relearning environment increases, an agent such as a robot may have a policy for adapting to more various environments, but the disadvantage is that learning convergence takes a long time and is inefficient. Furthermore, various attempts using an actual robot in the real world are accompanied by risk with respect to stability and cost. Accordingly, in embodiments of the present disclosure, for a problem faced in the real world, its possibility is verified safely and effectively through a simulation of a local and cloud environment, and effective relearning may be performed through a domain randomization strategy for each type in Table 2 below. Herein, Table 2 below describes criteria for classifying failure types of performing a task and strategies for applying domain randomization to an environment during relearning.

TABLE 2

| Failure type | Domain randomization strategy |
|---|---|
| Recognition | Change the color, texture, lighting and position of a |
| failure (based | target object |
| on the exterior | Parameters of camera sensor |
| form and class | Focal length, principal point, skew coefficient, etc. |
| of a target object) | Mix classes of target objects |
| | Learning of discernment by placing target objects |
| | with similar classes |
| Manipulation | Place various target objects with a same class |
| failure (based on | Change an initial location and position of a target |
| the shape of a | object |
| target object and a | Change the physical property of a robot manipulator |
| robot manipulator) | Weight, rotational inertia, and coefficient of |
| | friction of a robot gripper |
| | Change the physical property of a target object |
| | Weight, rotational inertia, coefficient of friction, etc. |
| Collision avoidance | Generate random obstacle in a surrounding |
| failure | environment and then change color, texture, |
| (Obstacle, wall and | lighting and shape |
| other surrounding | Change initial location and position of random |
| environments) | obstacles |
| | Change size scales of random obstacles |
| | Change initial linear velocity and angular |
| | velocity of random obstacles |
| | Apply external force to random obstacles |
| | Change the physical property of random obstacles |
| | Weight, rotational inertia, coefficient of friction, etc. |

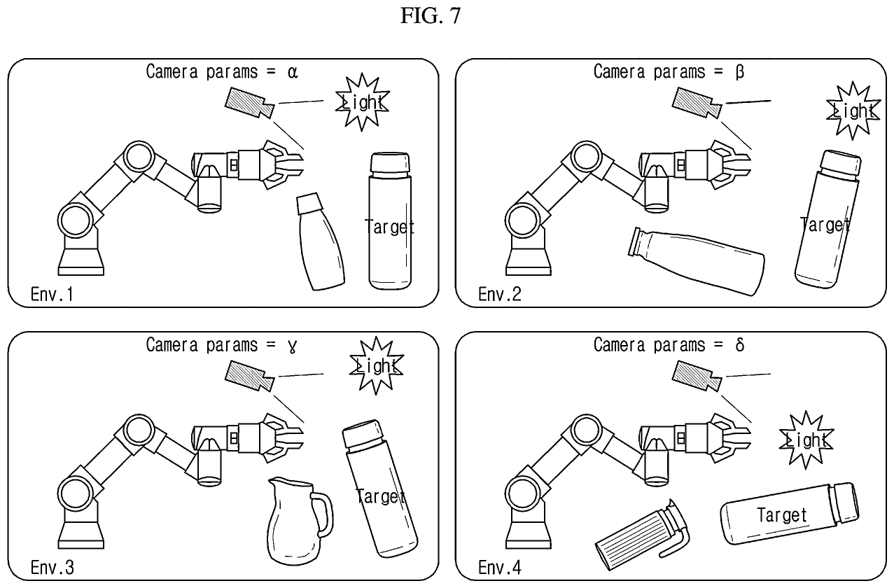

Recognition failure is a case of failing a target object rightly, and there may be various causes like a new class of objects, which is completely unfamiliar, a familiar object which makes the distribution of an input image significantly different depending on color, texture, position and lightning, and the like. Accordingly, as shown in Table 2, a domain randomization strategy for recognition failure may include changing the color, texture, lighting and position of a target object and the parameters of a camera sensor at random in each learning episode and also placing similar classes of objects together, and thus discernment may be learned. Such a randomization strategy may make it possible to learn a recognition technique robust against the change and distortion of distribution of input images caused by various factors. For example, as illustrated in FIG. 7, in the case of recognition failure, a domain randomization strategy may be performed using a change in the parameters of a camera sensor (camera params).

Manipulation failure means a case of failing in succeeding a task by manipulating a target object, and its main causes are the complexity of shape of the target object, the lack of manipulating skill and the like. In addition, physical properties of a target object and a robot manipulator such as coefficient of friction, weight, and rotational inertia may be causes. In order to solve such limitations, domain randomization for manipulation failure basically includes changing physical properties of a target object and a robot manipulator and applying a change in initial location and position of a target object.

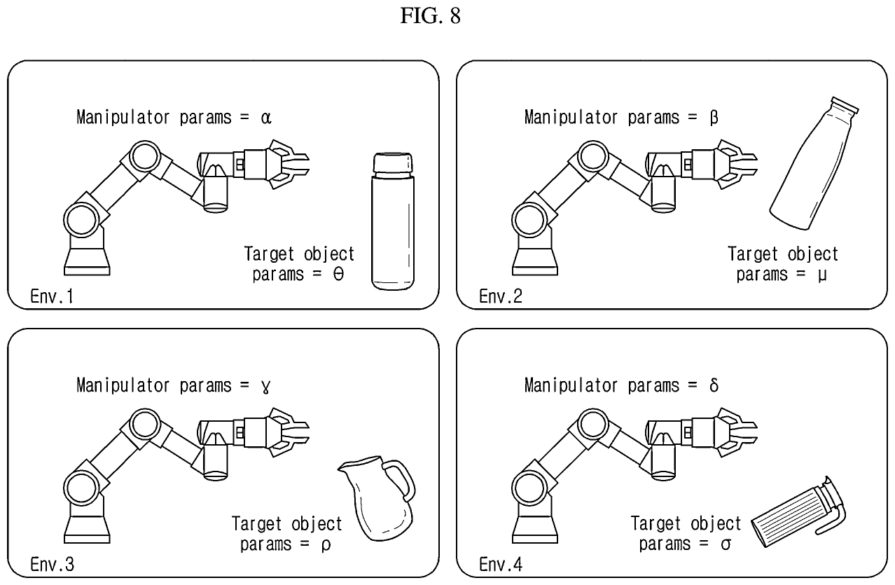

In addition, as mesh models of various target objects in a same class are randomly placed from an environment and an object DB, which are constantly updated, a robot agent may be configured to experience more diverse objects during a relearning process. Through a domain randomization strategy of manipulation failure, a robot is capable of learn a generalized manipulation skill for more diverse shapes and physical properties of target objects. For example, as illustrated in FIG. 8, in the case of manipulation failure, a domain randomization strategy may be performed using a change in the parameters of a manipulator (manipulator params) and the parameters of a target object (target object params).

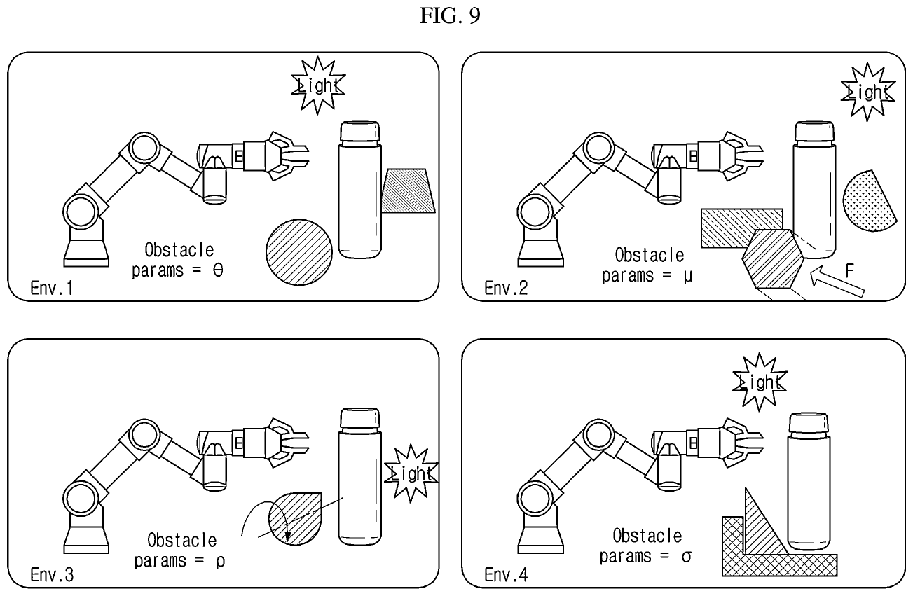

Collision avoidance failure means a case in which a robot agent collides with a surrounding environment like floor and wall and obstacles while it is performing a task. In the case of a static obstacle like a wall or a floor, learning may not face much difficulty by a Lidar sensor, a depth sensor and other sensors capable of recognizing a distance. However, obstacles in an actual environment change their states dynamically, and an accurate change of such a state is very difficult to predict. Accordingly, in order to avoid collision with an obstacle, it is necessary to learn a skill to react to an obstacle that dynamically changes, and in this regard, a domain randomization strategy of collision avoidance failure needs to consider a dynamic state change as well as a visual change of an obstacle. For example, as shown in Table 2 above, by changing the color, texture, lighting, shape and scale in a surrounding environment and obstacles, a robot agent may be configured to experience various visual distributions. In addition, it is necessary to consider not only the physical properties of obstacles such as weight, rotational inertia and coefficient of friction but also dynamic state changes like linear velocity and angular velocity. Considering an unexpected situation that may occur in the real world, an external force may be applied to an obstacle in a simulator in order to a dynamic state change. Through such a domain randomization strategy to overcome collision avoidance failure, a robot agent can learn a skill to avoid collision with a surrounding environment in various situations, which may occur in the real world, and to accomplish a given mission by reacting properly to the situations. For example, as illustrated in FIG. 9, in the case of collision avoidance failure, a domain randomization strategy may be performed using a change in the parameters of an obstacle (obstacle params).

Thus, a locally-adaptive local device learning method according to an embodiment of the present disclosure may effectively perform exploration and relearning for a variable environment through a simulation using a cloud computing resource mainly in a situation, in which a local device faces in a local environment, and thus reduce a load on a cloud server and also reduce risk of failure in performing a task in an actual environment.

When utilizing such a locally-adaptive local device learning method according to an embodiment of the present disclosure, as robots are deployed to each family and each organization, the possibility of succeeding a task may be verified quickly and effectively through a local simulation, and as a result, the risk and cost for failure of task in an actual environment may be reduced. In addition, for task adaptation in an unfamiliar environment, adaptive learning focusing on failure types may be performed fast by using massive cloud computing resources. In particular, since a locally-adaptive local device learning method according to an embodiment of the present disclosure performs adaptive learning tailored to a failure type, adaptive learning is performed mainly on skills that a robot agent lacks, and thus more effective learning may be performed. Such a local and cloud-based adaptive learning environment may secure more diverse data along with an expanded service, and thus generalized task intelligence learning may be effectively performed.

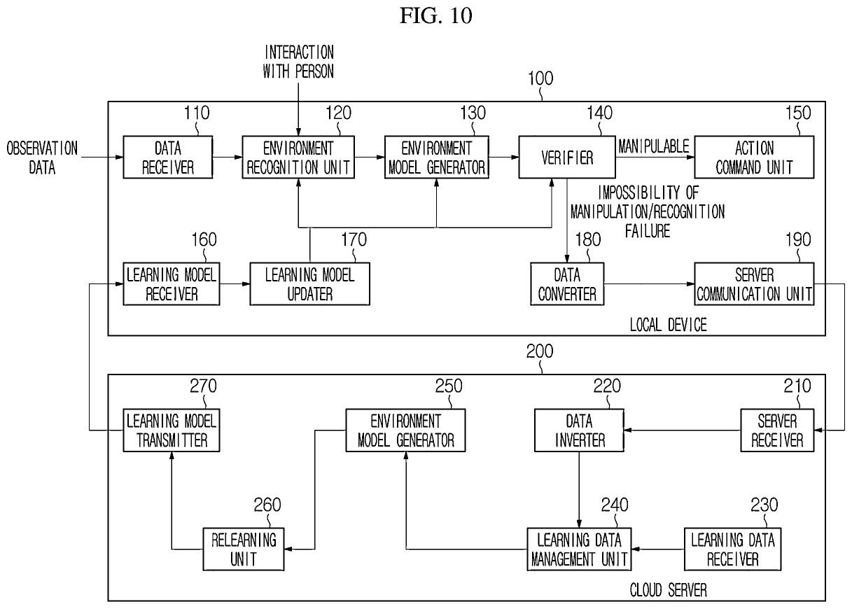

FIG. 10 is a view showing a configuration of a locally-adaptive local device task learning system according to another embodiment of the present disclosure, and this view shows a configuration of a system including a local device and a cloud server. Of course, an apparatus for learning a locally-adaptive local device task according to an embodiment of the present disclosure may be embodied as a system including a local device and a cloud server, an apparatus including only a local device, or an apparatus including only a cloud server.

Referring to FIG. 10, a local device 100 includes a data receiver 110, an environment recognition unit 120, an environment model generator 130, a verifier 140, an action commendation unit 150, a learning model receiver 160, a learning model updater 170, a data converter 180, and a server communication unit 190, and a cloud server 200 includes a server receiver 210, a data inverter 220, a learning data collection unit 230, a learning data management unit 240, an environment model generator 250, a relearning unit 260, and a learning model transmitter 270.

As for the local device 100, the data receiver 110 receives observation data that is collected using a RGB sensor, a depth sensor, and a Lidar sensor.

The environment recognition unit 120 recognizes a person's command and whether or not there is a target object through interaction between the received observation data and the person and provides a recognition result to the environment model generator 130.

The environment model generator 130 configures a local simulation environment for simulating the manipulation of a robot based on an environment of the current observation data.

The verifier 140 predicts the possibility of performance or the possibility of success by performing an actual task simulation from an environment model, which is constructed by the environment model generator 130, and when manipulation is determined to be possible, performs an actual task assigned by the action command unit 150, and when the impossibility of manipulation and the failure of recognition are determined, data encoding is performed after forwarding to the data converter 180.

The server communication unit 190 transmits data, which is converted by the data converter 180, to the cloud server 200, and the data thus transmitted may include observation data, an environment recognition result, and a current policy network of a robot.

The learning model receiver 160 receives a relearned policy network for an assigned task of the robot 100 form the cloud server 200, and the learning model updater 170 updates the relearned policy network as a policy network of the robot. Herein, the learning model updater 170 may update a configuration means associated with a policy network of an assigned task, for example, the network of the environment recognition unit 120, the environment model generator 130, and the verifier 140. Of course, depending on situations, a policy network may be configured only in the verifier 140, and a policy network to be updated may be included in various configurations by various embodiments.

As for the cloud server 200, the server receiver 210 receives data transmitted by the local device 100 and forwards the data to the data inverter 220, and the data inverter 220 decodes and forwards the received data to the learning data management unit 240.

The learning data collection unit 230 collects various data associated with the technology of the present disclosure from a plurality of local devices connected to the cloud server 200 and holds or stores the data, and the learning data collection unit 230 may be managed by the learning data management unit 240 and receive and store various data of a local device through the learning data management unit 240.

The learning data management unit 240 may not only store and forward data of the local device 100, which is received through the data inverter 220, to the learning data collection unit 230 but also receive or retrieve various data for relearning a policy network of the local device from the learning data collection unit 230. That is, the learning data management unit 240 may retrieve or obtain, in the learning data collection unit 230, data received through the data inverter 220, for example, observation data, an environment recognition result, and associated data for learning by means of a policy network for an assigned task of a robot.

Herein, the learning data management unit 240 may combine data received through the data inverter 220 and associated data retrieved or received from the learning data collection unit 230 in various manners and provide combined data to the environment model generator 250.

The environment model generator 250 generates or performs a domain randomization with various variables being applied mainly on a part, in which the possibility of failing to perform a task is determined to be high, by using data received from the learning data management unit 240.

Herein, the environment model generator 250 may perform the domain randomization only when necessary with respect to recognition, manipulation and collision avoidance, since domain randomization on every element demands a lot of time and costs.

When various domain-randomized environments are configured by the environment model generator 250, in order to enhance the success rate in performing a task assigned to the local device 100 and a task on an environment based on the various environments, the relearning unit 260 relearns a policy network, and when relearning is completed, transmits the relearned policy network to the local device 100 via the learning model transmitter 270.

By updating the policy network received from the cloud server 200, that is, by updating the policy network that is relearned through domain randomization, the local device 100 may enhance the possibility of succeeding an assigned task by using the updated policy network.

Although not described in the system or apparatus of FIG. 10, a system or apparatus according to an embodiment of the present disclosure may include all the contents described in FIG. 1 to FIG. 9, which is apparent to those who have skill in the art.

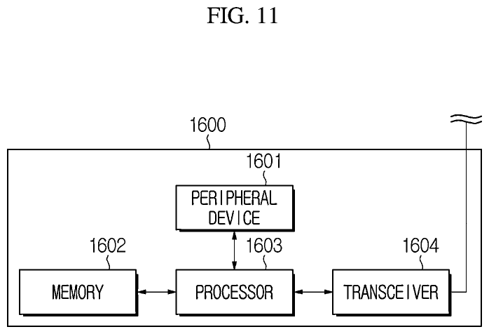

FIG. 11 is a view illustrating a configuration of a device to which an apparatus for learning a locally-adaptive local device task is applied according to another embodiment of the present disclosure.

The apparatus for learning a locally-adaptive local device task according to an embodiment of the present disclosure of FIG. 10 may be a device 1600 of FIG. 11. Referring to FIG. 11, the device 1600 may include a memory 1602, a processor 1603, a transceiver 1604 and a peripheral device 1601. In addition, for example, the device 1600 may further include another configuration and is not limited to the above-described embodiment. Herein, for example, the device 1600 may be a mobile user terminal (e.g., a smartphone, a laptop, a wearable device, etc.) or a fixed management device (e.g., a server, a PC, etc.).

More specifically, the device 1600 of FIG. 11 may be an exemplary hardware/software architecture such as a policy network relearning device, a robot learning model update device and a cloud simulation-based relearning device. Herein, as an example, the memory 1602 may be a non-removable memory or a removable memory. In addition, as an example, the peripheral device 1601 may include a display, GPS or other peripherals and is not limited to the above-described embodiment.

In addition, as an example, like the transceiver 1604, the above-described device 1600 may include a communication circuit. Based on this, the device 1600 may perform communication with an external device.

In addition, as an example, the processor 1603 may be at least one of a general-purpose processor, a digital signal processor (DSP), a DSP core, a controller, a micro controller, application specific integrated circuits (ASICs), field programmable gate array (FPGA) circuits, any other type of integrated circuit (IC), and one or more microprocessors related to a state machine. In other words, it may be a hardware/software configuration playing a controlling role for controlling the above-described device 1600. In addition, the processor 1603 may be performed by modularizing the functions of the environment recognition unit 120, the environment model generator 130, the verifier 140, the action commendation unit 150, the learning model updater 170 and the data converter 180 of FIG. 10, or may be performed by modularizing the functions of the data inverter 220, the learning data management unit 240, the environment model generator 250 and the relearning unit 260 of FIG. 10.

Herein, the processor 1603 may execute computer-executable commands stored in the memory 1602 in order to implement various necessary functions of the apparatus for learning a locally-adaptive local device task. As an example, the processor 1603 may control at least any one operation among signal coding, data processing, power controlling, input and output processing, and communication operation. In addition, the processor 1603 may control a physical layer, an MAC layer and an application layer. In addition, as an example, the processor 1603 may execute an authentication and security procedure in an access layer and/or an application layer but is not limited to the above-described embodiment.

In addition, as an example, the processor 1603 may perform communication with other devices via the transceiver 1604. As an example, the processor 1603 may execute computer-executable commands so that the apparatus for learning a locally-adaptive local device task may be controlled to perform communication with other devices via a network. That is, communication performed in the present invention may be controlled. As an example, the transceiver 1604 may send a RF signal through an antenna and may send a signal based on various communication networks.

In addition, as an example, MIMO technology and beam forming technology may be applied as antenna technology but are not limited to the above-described embodiment. In addition, a signal transmitted and received through the transceiver 1604 may be controlled by the processor 1603 by being modulated and demodulated, which is not limited to the above-described embodiment.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present invention by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

What is claimed is:

1. A method for learning a locally-adaptive local device task, the method comprising:
receiving observation data about a surrounding environment recognized by a local device;
performing a domain randomization based on the observation data and a failure type of a task assigned to the local device and relearning a policy network of the assigned task based on the domain randomization; and
updating a policy network of the local device for the assigned task by transmitting the relearned policy network to the local device.

2. The method of claim 1, wherein the relearning performs the domain randomization by reflecting data about the failure type collected from at least one or more other local devices.

3. The method of claim 1, wherein the failure type of the assigned task comprises at least one of recognition failure, manipulation failure, or collision avoidance failure or combination thereof.

4. The method of claim 3, wherein the relearning performs the domain randomization by using, in case of the recognition failure, at least one strategy among a change of a target object in color, texture, lighting and position, parameters of a camera sensor, and class mixture of the target object.

5. The method of claim 3, wherein the relearning performs the domain randomization by using, in case of the manipulation failure, at least one strategy among placement of a plurality of target objects with a same class, a change of an initial location and a position of the target object, a change in a physical property of a manipulator of the local device, and a change in a physical property of the target object.

6. The method of claim 3, wherein the relearning performs the domain randomization by using, in case of the collision avoidance failure, at least one strategy among generation of random obstacles and then a change in color, texture, lighting and shape, a change in an initial location and a position of the random obstacles, a change in a size scale of the random obstacles, a change in an initial linear velocity and an angular velocity of the random obstacles, application of an external force to the random obstacles, and a change in a physical property of the random obstacles.

7. The method of claim 1, wherein the receiving receives the observation data, a surrounding environment recognition result recognized by a local simulation of the local device, and the policy network of the assigned task.

8. A method for learning a locally-adaptive local device task, the method comprising:
obtaining observation data about a surrounding environment;
configuring a local simulation environment by using the observation data;
predicting possibility of success for an assigned task by using the local simulation environment;
requesting, to a cloud server, relearning of a policy network of the assigned task, when the assigned task is determined to be failure; and
updating the policy network of the assigned task by receiving a relearned policy network from the cloud server.

9. The method of claim 8, wherein the requesting of the learning requests relearning of the policy network of the assigned task by providing, to the cloud server, the observation data, the local simulation environment, and the policy network of the assigned task.

10. The method of claim 8, wherein the predicting of the possibility of success predicts possibility of success for at least one of recognition of a target object for the assigned task, manipulation of the target object, or collision avoidance with an obstacle or combination thereof.

11. An apparatus for learning a locally-adaptive local device task, the apparatus comprising:
a receiver configured to receive observation data about a surrounding environment recognized by a local device;
a relearning unit configured to perform a domain randomization based on the observation data and a failure type of a task assigned to the local device and to relearn a policy network of the assigned task based on the domain randomization; and
a transmitter configured to transmit the relearned policy network to the local device so as to update a policy network of the local device for the assigned task.

12. The apparatus of claim 11, wherein the relearning unit is further configured to perform the domain randomization by reflecting data about the failure type collected from at least one or more other local devices.

13. The apparatus of claim 11, wherein the failure type of the assigned task comprises at least one of recognition failure, manipulation failure, or collision avoidance failure or combination thereof.

14. The apparatus of claim 13, wherein the relearning unit is further configured to perform the domain randomization by using, in case of the recognition failure, at least one strategy among a change of a target object in color, texture, lighting and position, parameters of a camera sensor, and class mixture of the target object.

15. The apparatus of claim 13, wherein the relearning unit is further configured to perform the domain randomization by using, in case of the manipulation failure, at least one strategy among placement of a plurality of target objects with a same class, a change of an initial location and a position of the target object, a change in a physical property of a manipulator of the local device, and a change in a physical property of the target object.

16. The apparatus of claim 13, wherein the relearning unit is further configured to perform the domain randomization by using, in case of the collision avoidance failure, at least one strategy among generation of random obstacles and then a change in color, texture, lighting and shape, a change in an initial location and a position of the random obstacles, a change in a size scale of the random obstacles, a change in an initial linear velocity and an angular velocity of the random obstacles, application of an external force to the random obstacles, and a change in a physical property of the random obstacles.

17. The apparatus of claim 11, wherein the receiver is further configured to receive the observation data, a surrounding environment recognition result recognized by a local simulation of the local device, and the policy network of the assigned task.
